(19) United States
(12) Patent Application Publication
(10) Pub. No.: US 2009/0064569 A1
(43) Pub. Date: Mar. 12, 2009

(54) Pelletising of Fibrous Combustible Material at Variable Pressure and Variable Temperature

(76) Inventor: Abhay Kumar Khater, New Delhi (IN)

Correspondence Address: ALBERT W. WATKINS, 30844 NE 1ST AVENUE, ST. JOSEPH, MN, 56374, US

(21) Appl. No.: 12/206,686

(22) Filed: Sep. 8, 2008

Related U.S. Application Data
(60) Provisional application No. 60/967,724, filed on Sep. 6, 2007.

(51) Int. Cl. C10L 5/40; B28B 17/00

(52) U.S. Cl. 44/589; 425/144

(57) ABSTRACT

Fibrous combustible material such as biomass or biomass refuse is coarse chopped, dried and then may optionally loaded, transported, and unloaded. The biomass is further processed to a desired size and bulk density. Low speed knife cutters are used for cutting the fiber instead of crushing. Fibrous combustible material having a moisture content of approximately 20% and a temperature of approximately 70-80° C. is extruded between rollers and a fixed flat die, and releases glutinous juices during extrusion which enable pellet formation while also producing a polished cover to the extruded pellet during simple air cooling. A low and variable speed of 2-3 meters per second between rollers and fixed flat die is used for pelletising fibrous biomass. A desired temperature of the fixed flat die is maintained by circulating hot or cold water.

### CROSS REFERENCE TO RELATED APPLICATIONS

This application claims priority to U.S. provisional patent application 60/967,724 filed Sep. 6, 2007, entitled “Densification of Low Density Fibrous Biomass Material by Pelletising for Fuel,” and naming the present inventor, the contents which are incorporated herein by reference in entirety.

### BACKGROUND OF THE INVENTION

1. Field of the Invention

This invention pertains generally to fuel and related compositions, and more particularly to methods and apparatus for consolidating solids of vegetation or refuse into pellets using variable pressure and variable temperature.

2. Description of the Related Art

North America generates several hundred million tons of fibrous residue. Common agricultural residues include corn stover, wheat straw and other straws, stalks, husks, cobs, hulls, and culls. Additional sources of fibrous residues include, though are certainly not limited to, paper and mixed wastes, and wood residues such as shavings and sawdust. India is estimated to produce more than five hundred million tons of non-fodder biomass residue including materials such as bagasse, rice husk, groundnut shell. While some of the biomass residue is being used as fuel, most non fodder stalk from agricultural fields, horticulture, and forest residues are not being utilized. Similar biomass residue is produced in most countries and continents of the world, with a very small percentage being used to produce fuel.

These various biomass residues offer little hope for economic value, with the notable exception of renewable energy production. Biomass is regenerated with each growing season, making it carbon-neutral, meaning growth sequesters the same amount of carbon that is later released during combustion. The biomass can be generated and collected manually or with common equipment directly from the surface of the earth. Biomass residue is a necessary by-product of other operations vital to life, such as the production of food, and so is also widely distributed geographically and available. In addition, with proper furnaces many types of biomass will burn very cleanly, producing little if any undesirable pollution. In contrast, the price of traditional fossil fuels has increased greatly recently, availability has decreased as the more easily extracted sources are being rapidly depleted, and pollution and atmospheric carbon release each remain a major concern.

In addition to biomass residue, consideration has been given to the intentional growing of various crops specifically for the ultimate use as an energy source. Corn and sugar cane are currently being grown and converted directly into ethanol, for ultimate use as a widely accepted diluent or substitute for gasoline. Various residues result from the ethanol production. Additional plants of interest include switch grass and binary grass, which are under consideration both for conversion into ethanol and also as a more direct source for combustible material.

Biomass and associated residue has a very low density, meaning unreasonably large volumes are required to produce significant energy when combusted. In addition, low density residue makes a load not only voluminous, but also difficult to transport, owing to the need to adequately enclose the load or to bale the biomass to prevent it from being dissipated in the wind. Most fibrous biomass as harvested additionally has high moisture content and odd size, making the existing method of baling, transport, and de-baling economically impractical. Any use must generally be made at the site where the biomass residue is generated. Furthermore, storage is similarly expensive and economically impractical, again owing to the low density and resulting large storage volumes required.

Another very undesirable side effect of the low density of biomass is the danger of unintended fire. The residue is ordinarily dried to prevent or slow biological decomposition. Unfortunately, the resulting combination of dried residue and substantial air content is extremely flammable. The danger of fire associated with straw piles and even baled straw stored in barns or other shelters is notoriously well known, and most residues of interest exhibit similar flammability.

In order to improve the safe and economical handling and storage of these residues, much development effort has been expended for well more than a century. Much of that effort has been directed at better ways to consolidate the residue and increase the density of the finished product. The residue is commonly consolidated into powders, pellets, blocks, wafers or briquettes using various presses or mills. The benefits associated with pellets, blocks, wafers, briquettes or the like is that the materials are self-supporting and sufficiently massive to be easily handled, dispensed, and transported with only negligible dusting or wind-dissipation.

In spite of the substantial development effort that has taken place, biomass and biomass residues are not being used in any large and economically competitive way as fuel after densification, resulting in much waste of a potentially valuable fuel source. Unfortunately, existing processes suffer from one or more of many very serious drawbacks. Among these are the need for complex, expensive, or unreliable equipment; the requirement for substantial energy to properly convert the fibrous source material into suitable pellets, which detracts from the beneficial energy production provided by the source material; and inadequate or unreliable production of suitably cohesive pellets.

While complex, expensive, unreliable or energy-intensive equipment are relatively self-explanatory, production of inadequate or unreliably cohesive pellets is not. One factor to cohesive pellets, which will not only adversely affect the density of the pellet, but also cohesion, is entrainment of air within a pellet. This air not only forms voids of weakness, it will also be entrained within the pellet during the compacting process, under substantial pressure. Consequently, when compacting pressure is released, there will be substantial force from the compressed entrained air to expand, literally destroying the pellet from the inside out.

An additional challenge to adequate pellet formation is the inherent resilience of most fibrous materials. Cellulosic fibers are inherently resilient, necessary for a plant to survive winds, rains and the like, and continue to flourish. This inherent characteristic is contrary to that desired for easy compaction. Instead of readily reforming during compaction, cellulosic fibers will tend to return to their original shape.

While various additives have been proposed to assist with compaction, these additives add cost and are difficult to admix with the biomass. Additional important chemical interactions may occur, and so the additives may adversely affect corrosion of apparatus, may adversely impact shelf-life and storage of pellets, and may render combustion ash useless as a fertilizer or even hazardous.

Exemplary of prior art compaction apparatus are U.S. Pat. No. 1,467,883 by Sizer, entitled “Machine for compressing or molding plastic substances;” U.S. Pat. No. 1,768,008 by Sizer, entitled “Machine for the molding of plastic substances;” U.S. Pat. No. 1,868,370 by Sizer, entitled “Machine for molding plastic substances;” U.S. Pat. No. 1,869,492 by O'Halloran, entitled “Compressing and molding machine;” U.S. Pat. No. 1,994,371 by Sizer, entitled “Molding machine;” U.S. Pat. No. 2,059,486 by Payne et al, entitled “Cubing machine;” U.S. Pat. No. 2,171,039 by Meakin, entitled “Mechanism for molding material;” U.S. Pat. No. 2,670,697 by Meakin, entitled “Pellet mill;” U.S. Pat. No. 2,902,715 by Norman, entitled “Extrusion-consolidation die;” U.S. Pat. No. 3,038,420 by Immohr, entitled “Extrusion die construction;” U.S. Pat. No. 6,582,638 by Key, entitled “Method of making granules and the granulator;” the contents and teachings of each which are incorporated herein by reference.

Additional patents propose various biomass pellets formed using characteristics of the biomass. Exemplary are U.S. Pat. No. 128,478 by Fleischmann, entitled “Improvement in Processes of Forming Blocks and Slabs from Green Grasses for Fuel and Other Purposes;” U.S. Pat. No. 2,296,516 by Goss, entitled “Briquette press;” U.S. Pat. No. 3,013,880 by King, entitled “Method of pelleting hay;” U.S. Pat. No. 4,015,951 by Gunnerman, entitled “Fuel pellets and method for making them from organic fibrous materials;” U.S. Pat. No. 4,519,808 by Stisen, entitled “Straw fuel briquette press;” U.S. Pat. No. 4,798,529 by Klinner, entitled “Apparatus and method for briquetting fibrous crop or like materials;” U.S. Pat. No. 4,810,446 by Sylvest, entitled “Method of making straw briquettes;” the teachings and contents of each which are also incorporated herein by reference.

Webster's New Universal Unabridged Dictionary, Second Edition copyright 1983, is further incorporated herein by reference in entirety for the definitions of words and terms used herein.

### SUMMARY OF THE INVENTION

In accord with the present invention, a method of coarse chopping of material, drying and mechanized loading, transport, and unloading enable harvested biomass to be economically processed. The biomass is further processed to a desired size and bulk density. Low speed knife cutters are used for cutting the fiber instead of crushing. In accord with the inventive extrusion process, material having a moisture content around 20% and a temperature around 70-80° C. releases glutinous juices which enable pellet formation, while also producing a polished cover to the extruded pellet during cooling. While prior art ring die pelletisers operate at very high pelletising speed of 7-8 meters per second between press and die, in accord with the present invention a low speed of 2-2.5 meters per second is required for pelletising fibrous biomass. A desired temperature of the fixed flat die is maintained by circulating hot or cold water.

In a first manifestation, the invention is a method of converting a fibrous combustible material, at a variable pressure which is optimally different for diverse fibrous combustible materials and at a variable temperature which is optimally different for diverse fibrous combustible materials, into pellets consisting essentially of the fibrous combustible material by pressing the diverse fibrous combustible material through a die. According to the method, a first relative speed is selected between a press wheel and die from a plurality of different available relative speeds which will extract sufficient glutinous juice from the fibrous combustible material to form pellets during pressing, the first relative speed which varies dependent upon the composition of fibrous combustible material. A first relative temperature for the die is chosen from a plurality of different available relative temperatures, the first relative temperature which will form pellets during pressing of fibrous combustible material through the die, the first relative temperature which varies dependent upon the composition of fibrous combustible material. The variable pressure and variable temperature are adjusted responsive to characteristics of the fibrous combustible material to a pressure produced by the first relative speed and to the first relative temperature to successfully pelletise fibrous combustible material. The fibrous combustible material is then pressed through the die at the adjusted variable pressure and adjusted variable temperature.

In a second manifestation, the invention is a method of collecting and converting fibrous combustible material into fuel pellets. According to the method, the fibrous combustible material is chopped and dried, and then ground subsequent to the chopping and drying steps, while preserving gelatinous material within fibrous combustible material to yield a dimensionally reduced fibrous combustible material. The dimensionally reduced fibrous combustible material is extruded between a press and a die at low speed to thereby exude gelatinous binding material from the dimensionally reduced fibrous combustible material.

In a third manifestation, the invention is a fixed hat die extruder for pelletising fibrous combustible material at variable pressure and variable temperature. An inlet receives fibrous combustible material into the fixed flat die extruder. At least one press wheel traverses a fixed die. A controlled and variable pressure is generated between press wheel, fibrous combustible material and die, and a controlled and variable temperature is maintained within the fixed die. An outlet releases fibrous combustible pellets formed from the fibrous combustible material out of the fixed flat die extruder.

### OBJECTS OF THE INVENTION

Exemplary embodiments of the present invention solve inadequacies of the prior art by providing an improved apparatus and method for pelletising fibrous combustible materials such as biomass residue. A first object of the invention is to provide pellets produced from biomass or biomass residue which are durable and dense, and which may readily be used in commercial furnaces and burners. A second object of the invention is to produce these pellets using apparatus and processes which require relatively insignificant energy for production. Another object of the present invention is to provide continuous, efficient production. A further object of the invention is to produce pellets from biomass residue without requiring the addition of further chemicals or other ingredients, instead relying solely upon the biomass residue for necessary binding while still yielding pellets which will survive normal handling without breakage. Yet another object of the present invention is to enable ready control and adjustment of important compaction process variables, including temperature and pressure.

### BRIEF DESCRIPTION OF THE DRAWINGS

The foregoing and other objects, advantages, and novel features of the present invention can be understood and appreciated by reference to the following detailed description of the invention, taken in conjunction with the accompanying drawings, in which:

FIG. 1 illustrates a preferred embodiment method designed in accord with the teachings of the present invention by flow chart.

FIG. 2 illustrates a preferred embodiment pellet mill designed in accord with the teachings of the present invention and used in the preferred method of FIG. 1 from a front partially cut-away plan view.

FIG. 3 illustrates a preferred embodiment flat die, designed in accord with the teachings of the present invention and used in combination with the preferred embodiment pellet mill of FIG. 2, from a top plan view.

### DESCRIPTION OF THE PREFERRED EMBODIMENT

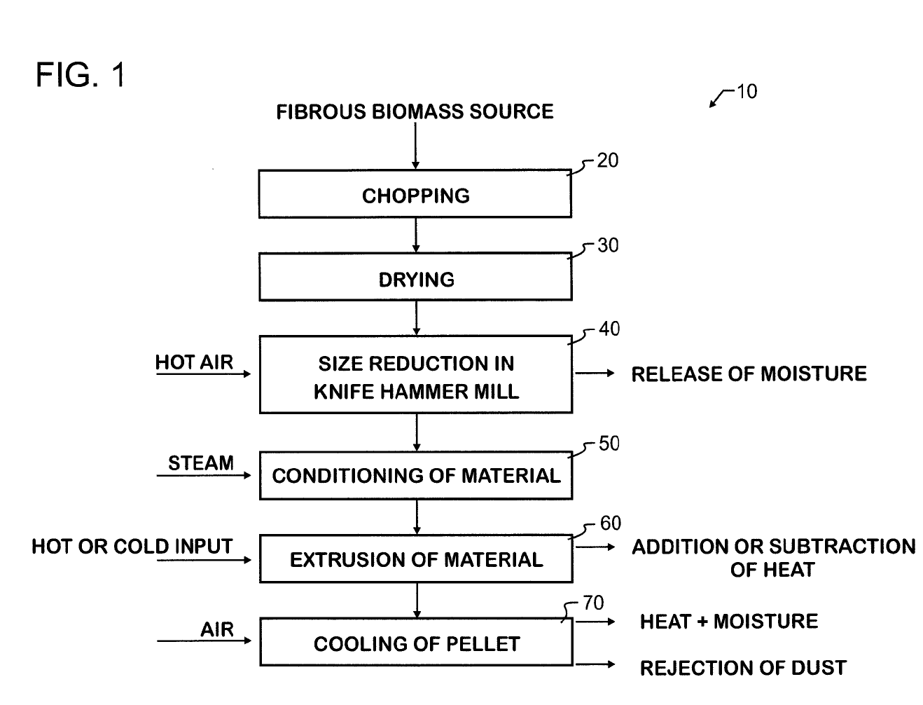

Manifested in the preferred embodiment apparatus and method, the present invention provides an economically viable way to convert biomass into fuel pellets. FIG. 1 illustrates a preferred method 10 of converting biomass into fuel pellets. Method 10 begins with a fibrous biomass source. This source may be any of a heretofore impossibly wide variation of biomass materials, including for exemplary purposes and not limited thereto, agricultural, business, or post-consumer residue, or plant matter produced specifically for use within preferred method 10. The bulk density of a typical fibrous biomass source will range between 30 and 40 kilograms per cubic meter (kg/m³), and the moisture content will typically range between 25 and 50%.

The fibrous biomass source is coarse chopped in step 20. This chopping may preferably be accomplished using a field chipper cutter. By chopping in or adjacent to the field, the fibrous biomass material will have an increased bulk density and more consistent size prior to any transport. This chopping enables stalky fibrous biomass source materials such as rice straw, cotton stalk, arhar stalk, cane trash and the like to be used. After chopping, bulk density will typically be increased about three-fold, to approximately 100-120 kg/m³.

Chopping 20 also further facilitates drying of fibrous bulk material at step 30. During drying step 30, moisture content is typically preferably reduced to between 15 and 25% moisture. Many materials like rice and other husk woody stalks are difficult to grind and have very high abrasion. After drying step 30, grinding these materials using a special hammer mill as described next is successful.

Size reduction occurs in step 40, most preferably using a special hammer mill having sharpened blades resembling knives, and preferably operating at a lower speed. Low speed knife cutters are used for cutting the fiber instead of crushing. This avoids making the material fluffy, while also preserving juices within the material. Hot air may preferably be introduced during this size reduction step 40, further reducing the moisture to between 10 and 15%. By using a knife hammer mill, size reduction at step 40 further increases bulk density, typically to between 140 and 160 kg/m³. The selection of a particular operating speed may be dependent upon the particular fibrous biomass source being processed, but will readily be determined by those reasonably skilled in the art in light of the present disclosure.

If so desired, after chopping 20, and also optionally after drying 30, and further optionally after size reduction 40, the fibrous biomass source may through mechanized loading, transport, and unloading be economically pelletised at some distance from the point of origin of the fibrous biomass source. Just prior to pelletising, the chopped, dried, size-reduced fibrous biomass material will preferably be conditioned at step 50 with steam, using techniques known in the art. This application of steam further assists with formation of reliable pellets.

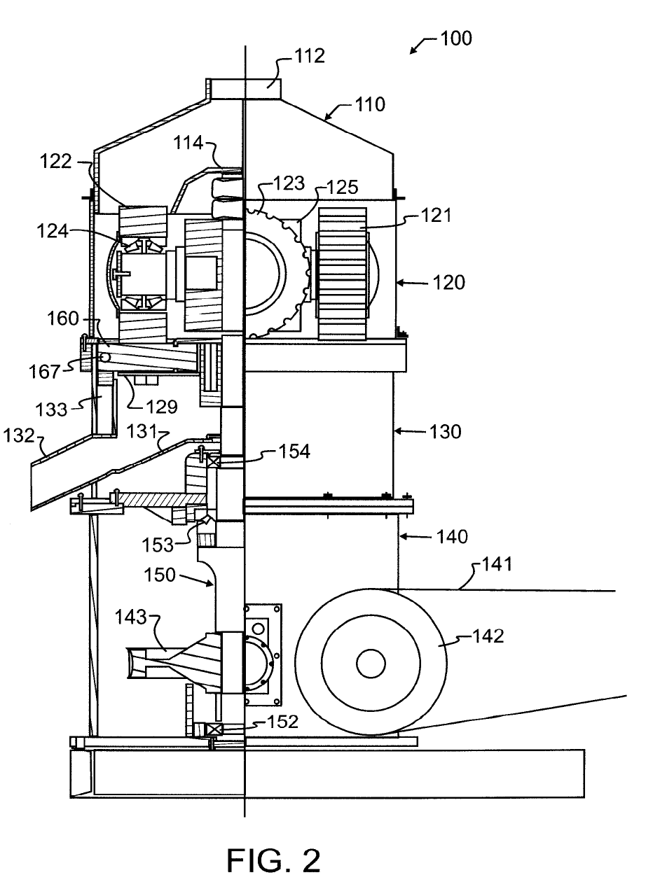

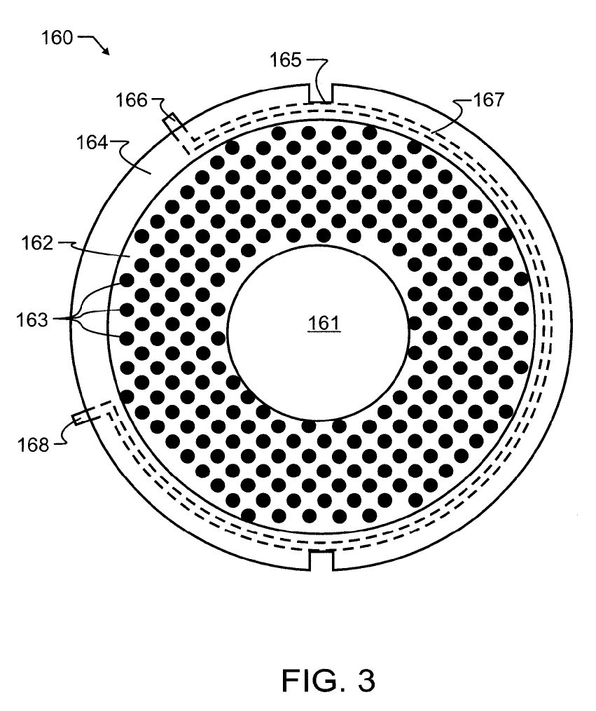

Subsequent to steam conditioning step 50, the biomass material will be extruded at step 60. A preferred pellet mill apparatus for extrusion step 60 is illustrated in FIGS. 2 and 3, and will be described in further detail herein below. Most preferably, extrusion step 60 incorporates a combination of pressure and temperature control. In a most preferred embodiment, pressure is controlled by controlling the rate of travel of the press rollers with respect to the die. Prior art ring die pelletisers operate at very high pelletising speed of 7-8 meters per second between press and die. In the preferred embodiment, this speed is well below the conventional speed of approximately 8 meters/second. A preferred range is between two and three meters/second, and a most preferred range is from two to two-and-one-half meters/second. Speed changes will in turn result in compacting pressure changes, and the preferred compacting pressure is most preferably adjustable to best match the demands of a particular composition of fibrous combustible material. Speed determination and adjustment may be made prior to or during extrusion of pellets.

Temperature control may be achieved by directly heating or cooling the die, or by controlling temperature of not only the die but additional adjacent equipment as well, or by relying entirely upon thermal conduction and thermally coupling of a heating and cooling source such as a temperature-controlled water line to the die. In this case, the die may be fully separable from the thermal sink, such as by being placed immediately adjacent to and in metal to metal contact with the temperature-controlled water line, without requiring any special fittings or couplings to the temperature-controlled water line. This ensures lower-cost dies that may be readily removed and replaced to work optimally with a particular biomass source. In accord with the inventive extrusion process, material having a moisture content around 20% and a temperature around 70-80° C. releases glutinous juices, which for exemplary purposes may comprise lignin. Release of these juices enables pellet formation, while also producing a polished cover to the extruded pellet during cooling. Temperature determination and adjustment may be made prior to or during extrusion of pellets, and will most preferably be controlled to form optimum pellets from a particular composition of fibrous combustible source material.

Cooling takes place at step 70, where in the preferred embodiment air flows past the pellets, removing heat and moisture. In the preferred embodiment, cooling step 70 also removes dust, by entraining any dust in the air stream. After cooling, preferred method 10 is complete. In one exemplary embodiment, pellets five to twenty-five millimeters in diameter (depending upon the die used) and twenty to fifty millimeters in length (depending upon settings for a cut-off knife) are produced, having a moisture content between ten and fifteen percent, and bulk density of 650-750 kg/m³.

In accord with the preferred method 10, biomass having a moisture content of 18-20% has been pelletised at step 60 satisfactorily. The resulting output moisture is between 12 and 15%. Because pelletising is done at a lower speed, pellet formation at low moisture is possible. This in turn enables normal air cooling to dry the pellet at step 70 to desired final moisture content. In contrast, the prior art, depending upon pellet size, used 20 to 28% moisture content. 24% was considered ideal moisture, with output moisture around 18%.

FIG. 2 illustrates a preferred which may be used to achieve preferred method extrusion step 60. As shown therein, pellet mill apparatus 100 comprises four major vertically stacked sections, intake section 110, extrusion section 120, collection section 130, and power transfer section 140. Additional major components include rotary shaft 150 and extrusion die 160.

Chopped, dried, ground, and steam conditioned material, for exemplary purposes having a bulk density of 120-140 kg/m³, is fed into the preferred embodiment pellet mill apparatus 100 through inlet 112. Canopy 114, in combination with gravitational forces, distributes the biomass material about extrusion section 120. The left half of FIG. 2 illustrates a quarter-section view, while the majority of the right half of FIG. 2 illustrates an exterior plan view. However, to best illustrate all aspects of the invention, extrusion section 120 on the right half has the exterior housing also removed, enabling a full non-sectioned view of the various extrusion components. As visible in the Figure, a plurality of gear-like rollers 121, 122, 123 (and a fourth roller, not visible) are spaced equally in ninety degree increments about centrally located rotary shaft 150. The number and spacing of gear-like rollers about rotary shaft 150 is not critical to the operation of the invention. While at least one such roller is required, any additional number of such rollers may be used. With larger numbers of rollers, more material may be extruded in a given amount of time. Additionally, in accord with the preferred embodiment, pairs of rollers opposed about shaft 150 are preferred. While not wishing to be solely limited hereto, pairs keep the forces more balanced about shaft 150. However, more than four rollers may also necessitate that the rollers be smaller and less massive, which may be undesirable. Rollers 121-123 may, for exemplary purposes, be coupled to rotary shaft 150 through a bearing block 125, finally coupling to the rollers through thrust bearings 124. These thrust bearings resemble those found on automobile wheels, and are so named since they must not only carry a load axially about the rotary axis, but they will also preferably roll smoothly and with a minimum amount of friction even when exposed to relatively large forces parallel to the rotary axis. Rollers 121-123 forcefully engage with a flat die 160, also referred to as a fixed flat die pelletiser. Most preferably, material falls on die 160 and never moves with respect to the die, which helps in getting the desired pressure on the material to produce easy extrusion of pellets. As rollers 121-123 move with respect to die 160, material is pressed through openings in the die. The material is extruded through die 160, and is cut to desired length by a blade such as blade 129 which may follow rollers 121-123 at a variable distance therewith, the setting which may be used to determine the length of extruded pellets.

The relative speed between rollers 121-123 and die 160 will, in combination with characteristics fixed within die 160 such as hole diameter and taper, determine the extrusion pressure applied to fibrous combustible material. Faster speeds must force more material through die 160, resulting in greater pressure upon the material. Varying the speed of rotary shaft 150 then provides a way to directly control and vary the extrusion pressure. Control of extrusion pressure is important to adapt to varying characteristics of the fibrous combustible material, and may be determined and preset, or may be varied during extrusion.

Once a pellet is cut or separated by blade 129 from die 160, the pellet will preferably fall within collection section 130 onto a sloped bottom 131 that ultimately leads pellets to shoot 132. Shoot 132 dispenses formed pellets from pellet mill apparatus 100 to an external collector, from which they may preferably be cooled according to cooling step 70 of preferred method 10. A jacket or water conduit may be provided through which water of controlled temperature may be passed, to control the temperature of die 160. This water may directly pass through die 160 as shown by water inlet 166, water conduit 167 and water outlet 168 of FIG. 3, with water conduit 167 visible in FIG. 2 in the preferred embodiment. As an alternative embodiment, thermal energy is conducted from water conduit 133 through adjacent metal into die 160. In accord with the present invention, a desired temperature of fixed flat die 160 is maintained by circulating hot or cold water through either water conduit 133 or water conduit 167. This temperature control in combination with the other features of the invention enables Hope Flower pelletising, and pelletising of other difficult source biomass.

Motive energy to operate pellet mill apparatus 100 may come from any suitable source, and in the preferred embodiment this power may be coupled into pellet mill apparatus 100 through a belt, chain, or other suitable power transmission apparatus 141. In the preferred embodiment, a belt or chain loop couples with pulley or sprocket 142, which internally turns a worm gear. The worm gear couples with a toothed gear 143, such that rotation of the worm gear causes slower rotation of toothed gear 143. Toothed gear 143 is rigidly coupled with rotary shaft 150, so movement of power transmission apparatus 141 will ultimately rotate rotary shaft 150. Rotary shaft 150 is held about an axis of rotation by a plurality of bearings, such as bottom bearing 152, thrust bearing 153, and upper bearing 154, for exemplary purposes. Speed control may be achieved directly at the source of motive energy, for exemplary purposes only and not limited thereto, such as by controlling the throttle of an internal combustion engine. Alternatively, speed control may be through additional transmission or gearing as may be desired. Regardless of how speed is controlled, this speed is preferably variable and may be set to rotate shaft 150 at a speed determined to be optimal for a particular fibrous combustible source material.

Denser pellets increase fuel efficiency. Using the preferred pellet mill apparatus 100, a specific density of 1100 kg/m³ has been achieved. A desired bulk density of 650 kg/m³ may be achieved, though it is dependent upon pellet size and packing. In contrast, in the prior art it had not been possible to produce pellets heavier than water, and bulk density was around 500 kg/m³.

Additionally, higher temperatures required during pelletising consume more energy, reducing the overall value of the fuel from pellets. In the prior art, temperatures of about 165° C. are required for pelletising. In accord with the present invention, pelletising has been done at a temperature of around 100-110° C., which is just sufficient to evaporate water. Sufficient time availability during pellet extrusion has reduced the temperature requirement.

Fixed die 160 is illustrated in greater detail in FIG. 3. A center hole 161 will encompass rotary shaft 150. Adjacent thereto is a perforate plate 162 having a plurality of holes 163 passing through fixed die 160 in a direction normal to the face of die 160 in contact with rollers 121-123. Biomass material being extruded will contact perforate plate 162 and be forced through holes 163 by rollers 121-123. These holes 163 determine the ultimate diameter of pellets produced therefrom.

Pellets of different size may then be produced for different application. Typical diameters of 8-10 millimeters (mm) are preferred for domestic application, while 22-25 mm diameter pellets may be preferred for industrial application. In contrast, prior art techniques are generally limited to maximum pellet sizes of up to 12 mm diameter. The variability enabled by the present invention is made possible by changing die thickness and operating pressure.

Different materials after processing steps such as coarse chopping drying and grinding will exhibit different bulk density and particle size distribution. This may require varying the length of the die holes 163 and their taper. This can be done conveniently in a flat die pelletiser in accord with the present invention by ready substitution of different fixed dies 160 to accommodate the needs of a particular biomass material or residue. To facilitate the changing of different dies, fixed die 160 has an outer rim 164 with one or more notches 165 formed therein. Notch 165 will align with a stop or protrusion that prevents fixed die 160 from rotating about the axis of rotary shaft 150, while still permitting fixed die 160 to be removed vertically from collection section 130 for replacement.

With appropriate control of temperature, roller speed, die geometry and moisture content, the present invention has industrial applicability to compact pellets from biomass materials that include not only easier materials, but also mustard stalk, jute fiber, cane trash, bamboo waste, and other difficult materials. As a result, the present invention has many tangible benefits over the prior art, including the very apparent increase in value of waste biomass, a reduction in greenhouse gas production owing to carbon neutrality of renewable biomass, a reduction in the quantity of fossil fuel imported by many countries, and the associated increase in rural or local employment in those areas where the present invention is implemented.

While the foregoing details what is felt to be the preferred embodiment of the invention, no material limitations to the scope of the claimed invention are intended. Further, features and design alternatives that would be obvious to one of ordinary skill in the art are considered to be incorporated herein. The scope of the invention is set forth and particularly described in the claims herein below.

I claim:

1. A method of converting a fibrous combustible material at a variable pressure, said variable pressure which is optimally different for diverse fibrous combustible materials, and at a variable temperature, said variable temperature which is optimally different for diverse fibrous combustible materials, into pellets consisting essentially of said fibrous combustible material by pressing said diverse fibrous combustible material through a die, comprising the steps of:
selecting a first relative speed between a press wheel and said die from a plurality of different available relative speeds, said first relative speed which will extract sufficient glutinous juice from said fibrous combustible material to form pellets during said pressing of said fibrous combustible material through said die, said first relative speed which varies dependent upon a composition of said fibrous combustible material;
choosing a first relative temperature for said die from a plurality of different available relative temperatures, said first relative temperature which will form pellets during said pressing of said fibrous combustible material through said die, said first relative temperature which varies dependent upon said composition of said fibrous combustible material;
adjusting said variable pressure and said variable temperature responsive to characteristics of said fibrous combustible material to a pressure produced by said first relative speed and to said first relative temperature to successfully pelletise said fibrous combustible material; and
pressing said fibrous combustible material through said die at said adjusted variable pressure and said adjusted variable temperature.

2. The method of converting a fibrous combustible material at a variable pressure and at a variable temperature of claim 1, further comprising the step of milling said fibrous combustible material using a knife hammer mill to produce a dimensionally reduced fibrous combustible material prior to said pressing step.

3. The method of converting a fibrous combustible material at a variable pressure and at a variable temperature of claim 1, wherein said die comprises a fixed flat die.

4. The method of converting a fibrous combustible material at a variable pressure and at a variable temperature of claim 1, further comprising the step of chopping said fibrous combustible material using a field chipper cutter.

5. The method of converting a fibrous combustible material at a variable pressure and at a variable temperature of claim 1, further comprising the step of conditioning said fibrous combustible material using steam prior to said pressing step.

6. The method of converting a fibrous combustible material at a variable pressure and at a variable temperature of claim 1, wherein said adjusting occurs simultaneously with said pressing step.

7. The method of converting a fibrous combustible material at a variable pressure and at a variable temperature of claim 1, wherein said first relative speed between said press wheel and said extrusion die is in the range of two to three meters per second.

8. The method of converting a fibrous combustible material at a variable pressure and at a variable temperature of claim 3, further comprising the step of exchanging said fixed flat die with a second fixed flat die different from said fixed flat die in at least one of die hole length and die hole taper.

9. A method of collecting and converting fibrous combustible material into fuel pellets, comprising the steps of:
chopping said fibrous combustible material;
drying said fibrous combustible material;
grinding subsequent to said chopping and drying steps while preserving gelatinous material within said fibrous combustible material to yield a dimensionally reduced fibrous combustible material; and
extruding said dimensionally reduced fibrous combustible material between a press and a die at low speed to thereby exude gelatinous binding material from said dimensionally reduced fibrous combustible material.

10. The method of collecting and converting fibrous combustible material into fuel pellets of claim 9, wherein said chopping step further comprises chopping said fibrous combustible material with a field chipper cutter.

11. The method of collecting and converting fibrous combustible material into fuel pellets of claim 9, wherein said grinding step further comprises grinding said fibrous combustible material with a knife hammer mill.

12. The method of collecting and converting fibrous combustible material into fuel pellets of claim 9, wherein said die further comprises a fixed flat die.

13. The method of collecting and converting fibrous combustible material into fuel pellets of claim 12, wherein said press further comprises at least one rotary press wheel which rolls about a horizontal axis, said horizontal axis rotating about a vertical axis, said rotary press wheel in contact with said fixed flat die during said rolling about said horizontal axis and rotating about said vertical axis.

14. The method of collecting and converting fibrous combustible material into fuel pellets of claim 9, further comprising the steps of:
selecting a first relative speed between said press and said die from a plurality of different available relative speeds, said first relative speed which will extract sufficient glutinous juice from said fibrous combustible material to form pellets during said extruding of said fibrous combustible material through said die, said first relative speed which varies dependent upon a composition of said fibrous combustible material;
choosing a first relative temperature for said die from a plurality of different available relative temperatures, said first relative temperature which will form pellets during said extruding of said fibrous combustible material through said die, said first relative temperature which varies dependent upon a composition of said fibrous combustible material; and
adjusting said first relative speed and said variable temperature responsive to characteristics of said dimensionally reduced fibrous combustible material to a pressure produced by said first relative speed and to said first relative temperature to successfully pelletise said fibrous combustible material.

15. A fixed flat die extruder for pelletising fibrous combustible material at variable pressure and variable temperature, comprising:
an inlet receiving said fibrous combustible material into said fixed flat die extruder;
at least one press wheel traversing a fixed die;
a controlled and variable pressure between said press wheel, said fibrous combustible material and said die;
a controlled and variable temperature within said fixed die; and
an outlet releasing fibrous combustible pellets formed from said fibrous combustible material out of said fixed flat die extruder.

16. The fixed flat die extruder of claim 15, wherein said at least one press wheel rolls about a horizontal axis.

17. The fixed flat die extruder of claim 16, wherein said horizontal axis further spins about a vertical axis.

18. The fixed flat die extruder of claim 15, further comprising a means to vary a speed of said traversal, wherein said speed varying means controls and varies said pressure.

19. The fixed flat die extruder of claim 15, further comprising temperature-controlled water thermally coupled with said fixed die and controlling said die temperature.
